(19) United States
(12) Patent Application Publication
(10) Pub. No.: US 2026/0327025 A1
(43) Pub. Date: Oct. 22, 2026

(54) AUTOMATIC CONVEYANCE VEHICLE AND CONVEYANCE FACILITY

(71) Applicant: RAPIDUS CORPORATION, Tokyo (JP)

(72) Inventors: Shinichiro Ito, Albany, NY (US); Akio Mashima, Albany, NY (US)

(21) Appl. No.: 19/673,295

(22) Filed: May 11, 2026

Related U.S. Application Data
(63) Continuation of application No. PCT/JP2024/029075, filed on Aug. 15, 2024.

(51) Int. Cl. B65G 67/02

(52) U.S. Cl. CPC B65G 67/02

(57) ABSTRACT

An automatic conveyance vehicle and a conveyance facility are provided that enable an article to be conveyed flexibly from an overhead conveyance vehicle to an article mounting device. The automatic conveyance vehicle travels on a floor surface. The automatic conveyance vehicle mainly includes a traveling part, a container mounting part, and an opening and closing part. The opening and closing part is provided above the container mounting part, and is movable between a first position directly above the container mounting part and a second position deviated from directly above the container mounting part.

### CROSS REFERENCE TO RELATED APPLICATIONS

This application is a continuation of International Application No. PCT/JP2024/029075, filed on Aug. 15, 2024, the entire contents of which are incorporated herein by reference.

### TECHNICAL FIELD

The present invention relates to an automatic conveyance vehicle and a conveyance facility.

### BACKGROUND ART

Conventionally, an overhead conveyance vehicle, that is, an overhead hoist transport (OHT) is used as a transport system for a semiconductor factory (see, for example, Patent Literature 1). An overhead conveyance vehicle is an automatic conveyance device that travels on a track installed on a ceiling and directly transfers a FOUP to a storage facility or a load port of a manufacturing device by a hoist mechanism that moves up and down by belt drive. The overhead conveyance vehicle is widely used as a main transport system in a 300 mm semiconductor factory and the like, and is used not only for in-process transport but also for inter-process and inter-factory transport.

### CITATION LIST

### Patent Literature

Patent Literature 1: JP 2024-10483 A

### SUMMARY OF INVENTION

### Technical Problem

On the other hand, depending on the situation of an overhead conveyance vehicle or a load port, it is difficult to unload a cargo directly from the overhead conveyance vehicle to the load port, or the unloading time becomes long.

An object of the present invention is to provide an automatic conveyance vehicle and a conveyance facility that enable an article to be transported flexibly from an overhead conveyance vehicle to an article mounting device.

### Solution to Problem

The automatic conveyance vehicle travels on a floor surface. The automatic conveyance vehicle includes a traveling part, an article mounting part, and an opening and closing part. The opening and closing part is provided above the article mounting part, and is movable between a first position directly above the article mounting part and a second position deviated from directly above the article mounting part.

### Advantageous Effects of Invention

According to the present invention, it is possible to provide an automatic conveyance vehicle and a conveyance facility that enable an article to be transported flexibly from an overhead conveyance vehicle to an article mounting device.

### BRIEF DESCRIPTION OF DRAWINGS

FIG. 1 is a schematic plan view of a conveyance facility according to a first embodiment of the present invention.

FIG. 2 is a perspective view of an automatic conveyance vehicle.

FIG. 3 is a block diagram illustrating a control configuration of the automatic conveyance vehicle.

FIG. 4 is a flowchart for explaining control of transferring a container from an overhead conveyance vehicle to the automatic conveyance vehicle.

FIG. 5 is a perspective view of the automatic conveyance vehicle stopped at a station.

FIG. 6 is a front view of the automatic conveyance vehicle stopped at the station.

FIG. 7 is a plan view of the automatic conveyance vehicle stopped at the station.

FIG. 8 is a perspective view of the automatic conveyance vehicle when an opening and closing part is at a first position.

FIG. 9 is a perspective view of the automatic conveyance vehicle when the opening and closing part is at a second position.

FIG. 10 is a perspective view of the automatic conveyance vehicle when the container is transferred from the overhead conveyance vehicle to the automatic conveyance vehicle.

FIG. 11 is a perspective view of the automatic conveyance vehicle and the overhead conveyance vehicle when the container is transferred from the overhead conveyance vehicle to the automatic conveyance vehicle.

FIG. 12 is a flowchart for explaining control of transferring the container from the automatic conveyance vehicle to a load port.

FIG. 13 is a perspective view illustrating part of a synchronous drive system.

FIG. 14 is a front view of the automatic conveyance vehicle stopped at the load port.

FIG. 15 is a perspective view of the automatic conveyance vehicle stopped at the load port.

FIG. 16 is a perspective view illustrating a first state in which a transfer mechanism moves a FOUP toward the load port side.

FIG. 17 is a perspective view illustrating a second state in which the transfer mechanism moves the FOUP toward the load port side.

FIG. 18 is a perspective view of an automatic conveyance vehicle according to a second embodiment of the present invention.

FIG. 19 is a front view of an automatic conveyance vehicle (stopped) according to a third embodiment of the present invention.

FIG. 20 is a front view of the automatic conveyance vehicle (during conveyance) according to the third embodiment of the present invention.

### DESCRIPTION OF EMBODIMENTS

### 1. First Embodiment

### (1) Basic Configuration of Conveyance Facility

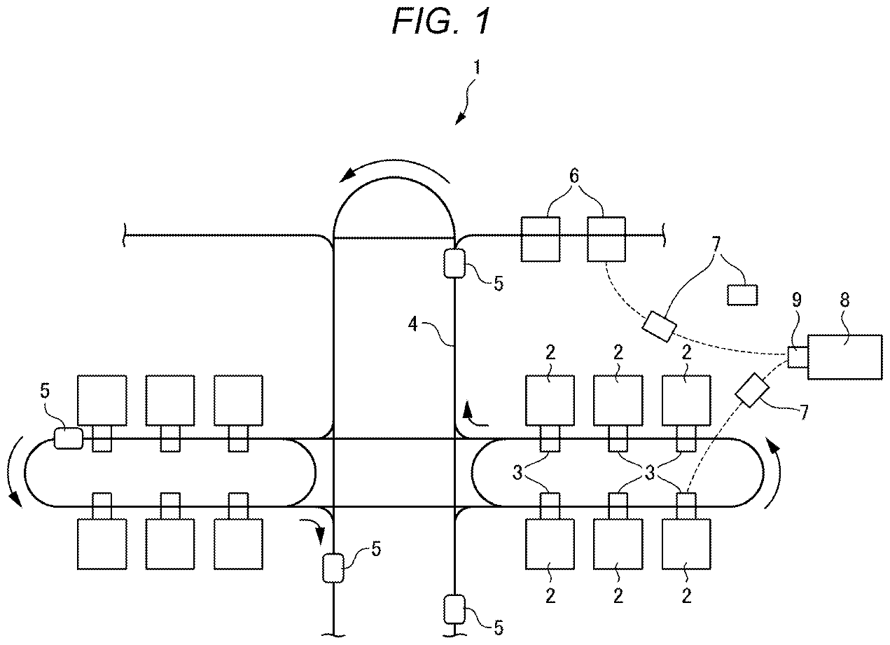

A conveyance facility 1 will be described with reference to FIG. 1. FIG. 1 is a schematic plan view of a conveyance facility according to a first embodiment of the present invention. In the present embodiment, the conveyance facility 1 is used in a semiconductor manufacturing factory.

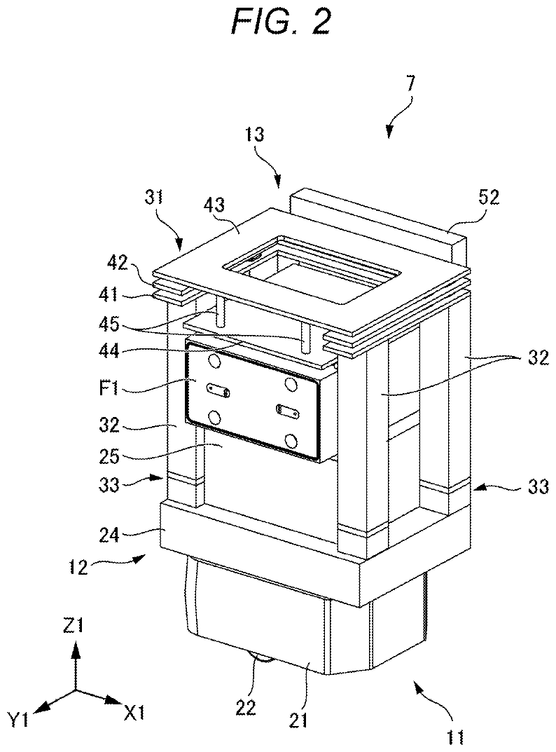

As illustrated in FIG. 1, the conveyance facility 1 includes a plurality of semiconductor processing apparatuses 2, a plurality of load ports 3 (article mounting devices apparatuses), a ceiling rail 4 (track), a plurality of overhead conveyance vehicles 5 that travel on the ceiling rail 4 and convey containers F1 (articles, FIG. 2), and an automatic conveyance vehicle 7.

The ceiling rail 4 is provided at a position spaced upward from the floor surface, specifically, near the ceiling.

The overhead conveyance vehicle 5 travels along the ceiling rail 4 and conveys the container F1 in a process of semiconductor processing or between processes. Each of the plurality of overhead conveyance vehicles 5 is configured to receive a conveyance command from a host controller (not illustrated) that integrally manages the conveyance facility 1 and execute a task according to the conveyance command. For example, the conveyance command includes information on a conveyance source and a conveyance destination of the container. The overhead conveyance vehicle 5 that has received the conveyance command conveys the container F1 from the conveyance source to the conveyance destination. The conveyance source and the conveyance destination include a plurality of semiconductor processing apparatuses 2 (specifically, a load port 3) and an automatic conveyance vehicle 7 (described later) located in a station 6 (described later).

The overhead conveyance vehicle 5 is a known technique, and has a traveling mechanism, a transfer mechanism, and a lifting mechanism. The transfer mechanism picks up the container F1 mounted on the load port 3 to be transferred by the traveling mechanism, and places the container F1 transferred by the traveling mechanism on the load port 3 to convey the container F1. The lifting mechanism has a lifting device and a plurality of lifting belts to raise and lower the transfer mechanism.

The plurality of semiconductor processing devices 2 are provided along the ceiling rail 4, and specifically, are placed below the ceiling rail 4. The semiconductor processing apparatus 2 may be, for example, an apparatus that performs pre-processing such as thin film formation, photolithography, and etching, or may be an apparatus that performs post-processing such as dicing, die attach, and wire bonding.

The load port 3 is placed adjacent to the semiconductor processing apparatus 2. The load port 3 functions as an inlet for carrying a substrate such as a wafer or a panel from the container F1 into the semiconductor processing apparatus 2.

The overhead conveyance vehicle 5 raises and lowers the container F1 to transfer the container F1 to and from the load port 3.

The container F1 is, for example, a substrate housing container (so-called front opening unified pod (FOUP)) that houses a substrate (a wafer, a panel, or the like), or a reticle housing container (so-called reticle pod) that houses a reticle. The FOUP houses, for example, a 600 mm×600 mm panel, and has a weight of, for example, 50 to 90 kg.

The conveyance facility 1 has an extra-track region semiconductor processing device 8 located at a position other than below the ceiling rail 4 and an extra-track region load port 9. Although only one combination of the extra-track region semiconductor processing device 8 and the extra-track region load port 9 is illustrated in FIG. 1, a plurality of combinations is actually provided. The positions of the extra-track region semiconductor processing device 8 and the extra-track region load port 9 are not limited.

### (2) Outline of Automatic Conveyance Vehicle

A plurality of the automatic conveyance vehicles 7 are placed in the conveyance facility 1. The automatic conveyance vehicle 7 is an unmanned conveyance vehicle that loads a conveyance object in a facility such as a factory or a warehouse and travels by power of a battery.

Each direction of the automatic conveyance vehicle 7 will be described with reference to FIG. 2. In the following description, an X1 direction, a Y1 direction, and a Z1 direction are directions orthogonal to each other. Specifically, the X1 direction, the Y1 direction, and the Z1 direction are directions based on the automatic conveyance vehicle 7. The X1 direction is a horizontal direction and is a front-rear direction of the automatic conveyance vehicle 7. The front-rear direction is, for example, a traveling direction of an automatic conveyance vehicle. The Y1 direction is the horizontal direction and is a direction (left-right direction) orthogonal to the X1 direction. Z1 is a vertical direction (up-down direction).

Each of the plurality of automatic conveyance vehicles 7 is configured to receive a conveyance command from a host controller (not illustrated) that integrally manages the conveyance facility 1 or the overhead conveyance vehicle 5 and execute a task according to the conveyance command. For example, the conveyance command includes information on a conveyance source and a conveyance destination of the container F1. The automatic conveyance vehicle 7 that has received the conveyance command conveys the container F1 from the conveyance source to the conveyance destination. The conveyance source and the conveyance destination include the extra-track region semiconductor processing device 8 (specifically, the extra-track region load port 9) and a station 6 (described later). In this case, as illustrated in FIG. 1, the automatic conveyance vehicle 7 conveys the container F1 by traveling between the extra-track region load port 9 and the station 6. Furthermore, as illustrated in FIG. 1, the automatic conveyance vehicle 7 can also convey the container F1 by traveling between the load port 3 and the extra-track region load port 9.

In the present embodiment, the automatic conveyance vehicle 7 receives the container F1 from the overhead conveyance vehicle 5 at the station 6, moves to the extra-track region load port 9, and delivers the container F1 to the extra-track region load port 9. Conversely, the automatic conveyance vehicle 7 receives the container F1 from the extra-track region load port 9, then moves to the station 6, and waits for the overhead conveyance vehicle 5 to receive the container F1.

The automatic conveyance vehicle 7 is, for example, an autonomous mobile robot (AMR), and autonomously travels using light detection and ranging (LIDAR) or other advanced sensors. The automatic conveyance vehicle 7 may be an automated guided vehicle (AGV), and travels along a wire, a magnet, a tape, a marked line, or the like embedded in a floor. In the present embodiment, the autonomous mobile robot (AMR) is adopted as the automatic conveyance vehicle 7, so that the conveyance of the article from the overhead conveyance vehicle to the article mounting device can be more flexibly performed.

### (3) Station

The conveyance facility 1 further includes a plurality of the stations 6. The station 6 is located below the ceiling rail 4 and is a space in which the automatic conveyance vehicle 7 is allowed to stop. The overhead conveyance vehicle 5 can transfer the container F1 by mounting the container F1 conveyed by the traveling mechanism on the automatic conveyance vehicle 7 stopped at the station 6. Furthermore, the overhead conveyance vehicle 5 can pick up the container F1 installed on the automatic conveyance vehicle 7 stopped at the station 6 in order to convey the container F1 by the traveling mechanism.

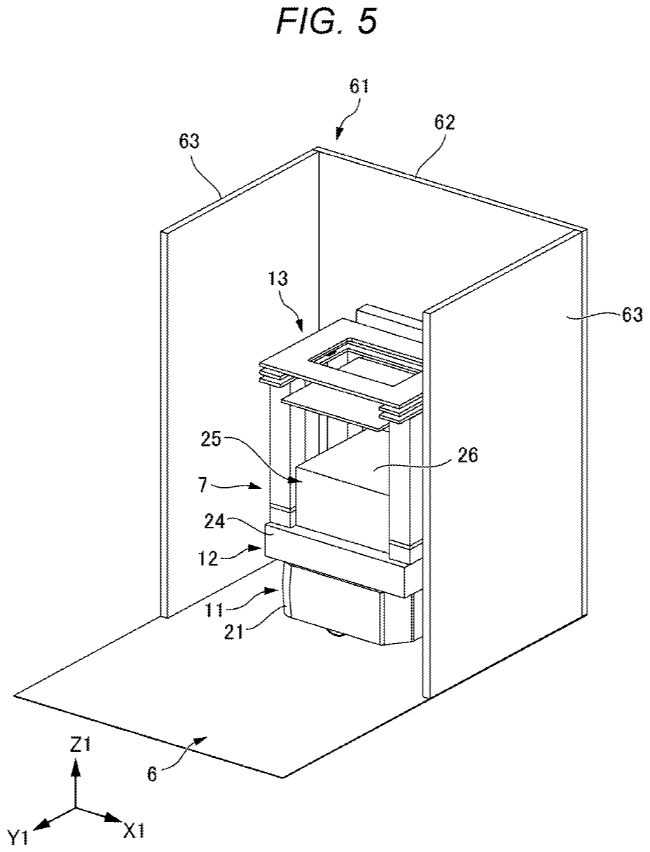

As illustrated in FIGS. 5 to 7, a fence 61 is provided around the station 6. FIGS. 5 to 7 are a perspective view, a front view, and a plan view of the automatic conveyance vehicle stopped at a station, respectively. The fence 61 is a wall for preventing or suppressing an operator from entering the station 6. The fence 61 has a first wall 62 and a pair of second walls 63 extending from both ends of the first wall 62 to the same side. The first wall 62 and the pair of second walls 63 are linear in plan view. In plan view, the angle between the first wall 62 and each of the pair of second walls 63 is 90 degrees. With the above structure, the automatic conveyance vehicle 7 can access the station 6 only from one place where the fence 61 is not provided with respect to the station 6. Note that the shape and material of the fence 61 are not particularly limited as long as it can block at least one side of the automatic conveyance vehicle 7 stopped at the station 6 to prevent the operator from entering the station 6.

### (4) Details of Automatic Conveyance Vehicle

The automatic conveyance vehicle 7 will be described in detail with reference to FIG. 2. FIG. 2 is a perspective view of an automatic conveyance vehicle.

The automatic conveyance vehicle 7 mainly has a traveling part 11, a container mounting part 12 (article mounting part), and an opening and closing part 13.

A traveling part 11 has a main body 21 that accommodates a motor and a battery. The traveling part 11 has wheels 22 driven by power from the motor.

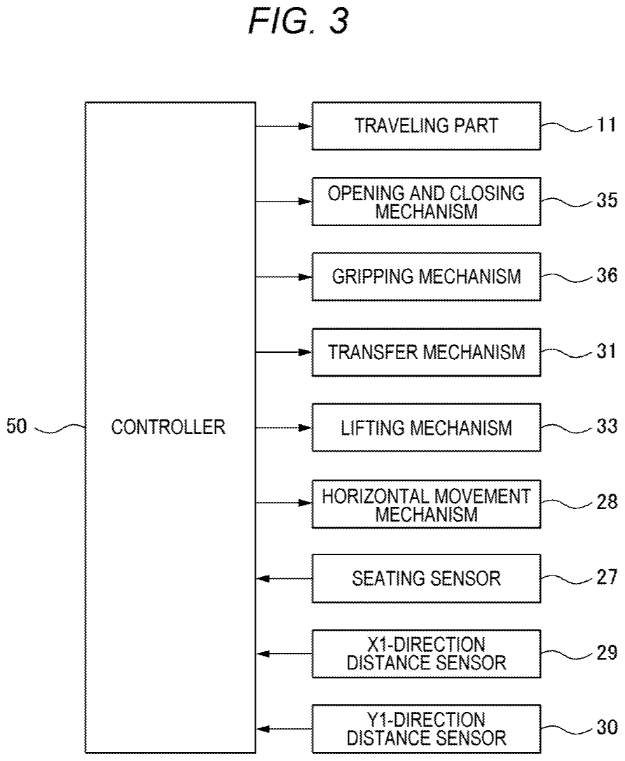

The container mounting part 12 is installed on the traveling part 11. The container mounting part 12 has a structure for supporting the container F1 from below. The container mounting part 12 has a mounting part main body 24 and a mounting member 25. The mounting member 25 is provided on the upper side of the mounting part main body 24 and has a container mounting surface 26 (FIG. 5). The container mounting surface 26 is provided with a kinematic pin (not illustrated) as a positioning pin for positioning the container F1, and a seating sensor 27 (FIG. 3) for detecting that the container F1 is positioned and mounted on the container mounting surface 26. Note that a battery (not illustrated) for driving the transfer mechanism 31 (described later) and an opening and closing mechanism 35 (described later) may be placed in the mounting member 25.

A horizontal movement mechanism 28 (FIG. 3) is provided between the traveling part 11 and the mounting part main body 24. The horizontal movement mechanism 28 is capable of moving the container mounting part 12 in the horizontal direction with respect to the traveling part 11. The horizontal movement mechanism 28 has, for example, an X-Y stage. The horizontal movement mechanism 28 only needs to be capable of moving the container mounting surface 26, which is part of the container mounting part 12, in the horizontal direction with respect to the traveling part 11. The horizontal movement mechanism 28 may be provided on the mounting member 25.

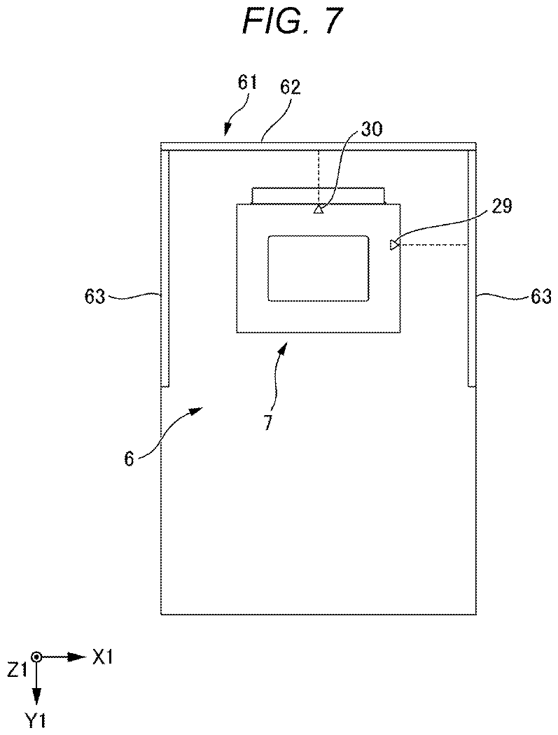

An X1-direction distance sensor 29 and a Y1-direction distance sensor 30 (sensor, FIG. 3, FIG. 7) are provided on the outer peripheral surface of the mounting part main body 24. The X1-direction distance sensor 29 is a sensor for measuring a distance to the second wall 63 of the fence 61. The Y1-direction distance sensor 30 is a sensor for measuring a distance to the first wall 62 of the fence 61. Each of the sensors has a light emitter and a light receiver of laser light. As a distance sensor, an ultrasonic wave may be used. In FIG. 7, one X1-direction distance sensor 29 and one Y1-direction distance sensor 30 are illustrated, but in order to enhance the accuracy of the stop position and the stop direction of the automatic conveyance vehicle 7, it is preferable that a plurality of X1-direction distance sensors 29 and a plurality of Y1-direction distance sensors 30 are provided.

The automatic conveyance vehicle 7 has four columns 32. The columns 32 stand upright at four corners of the upper surface of the mounting part main body 24. The column 32 incorporates a lifting mechanism 33, and an upper end portion thereof is movable in the up-down direction. The lifting mechanism 33 has, for example, a cylinder. As the lifting mechanism 33, a rack, a pinion, a ball screw, or another lifting mechanism may be used.

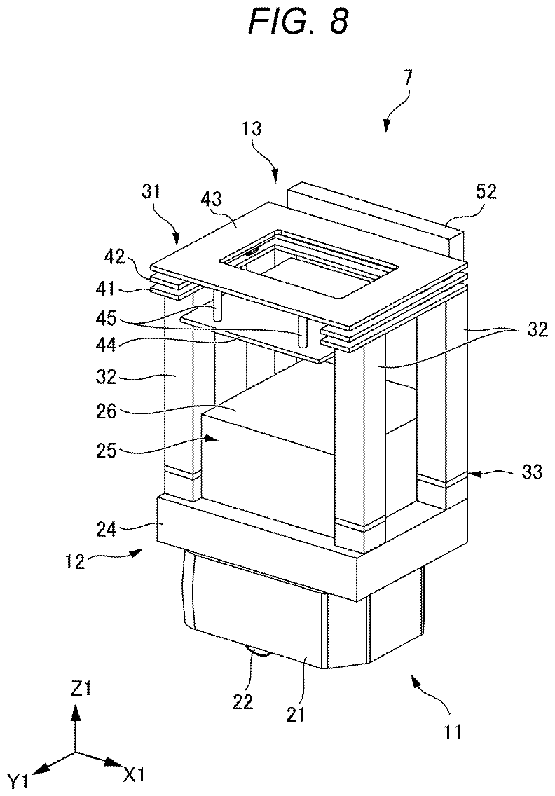

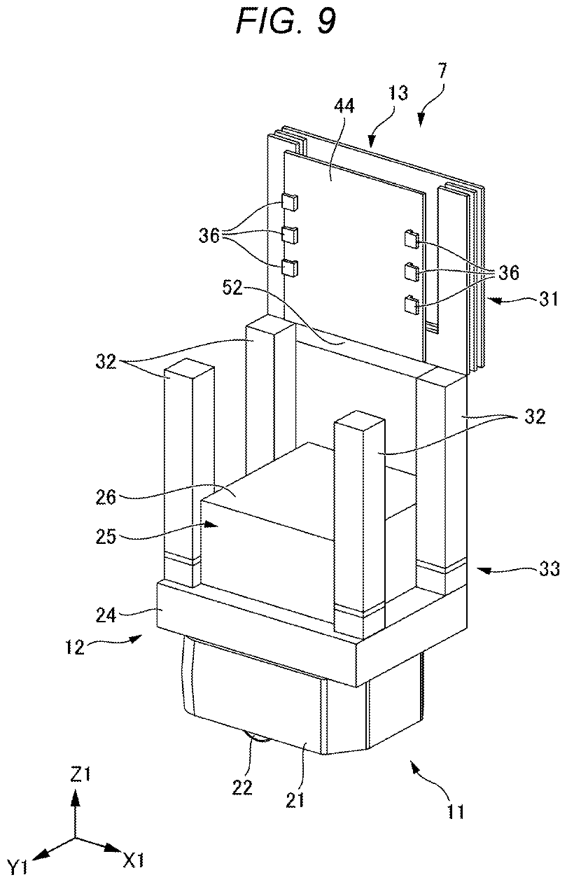

The opening and closing part 13 has a structure provided above the container mounting part 12. The opening and closing part 13 is movable between a first position (FIGS. 2 and 8) directly above the container mounting part 12 and a second position (FIG. 9) deviated from directly above the container mounting part 12. When the opening and closing part 13 is at the first position, top of the container mounting part 12 is closed. When the opening and closing part 13 is at the second position, the top of the container mounting part 12 is opened. Therefore, in the automatic conveyance vehicle 7, when the opening and closing part 13 is at the second position, the container F1 can be transferred from directly above the container mounting part 12. That is, the automatic conveyance vehicle 7 can directly receive the container F1 from the overhead conveyance vehicle 5.

Specifically, the opening and closing part 13 is swingably supported with respect to the column 32 via a hinge (not illustrated), and is in a horizontal posture at the first position and in an upright posture at the second position. The rotation axis of the hinge extends in the X1 direction. The opening and closing part 13 is moved from the first position to the second position and further moved from the second position to the first position by the opening and closing mechanism 35 (FIG. 3). The opening and closing mechanism 35 is a known technique and has an electric cylinder and a link mechanism.

The opening and closing part 13 has a transfer mechanism 31. The transfer mechanism 31 transfers the container F1 between the container mounting part 12 and the load port 3 by moving the container F1 to the side in a suspended state in a state in which the opening and closing part 13 is at the first position. Here, the side is a direction including the front-rear direction (X1 direction) and the left-right direction (Y1 direction) of the automatic conveyance vehicle 7 and including the horizontal direction. In the present embodiment, the transfer mechanism 31 transfers the container F1 between the container mounting part 12 and the load port 3 by moving the container F1 in the left-right direction in a suspended state. Specifically, the transfer mechanism 31 mainly has a fixing plate 41, a first moving plate 42, a second moving plate 43, and a gripping plate 44.

The fixing plate 41 is placed on upper ends of the four columns 32. The fixing plate 41 has a U shape in plan view in which one side in the Y1 direction is opened. The fixing plate 41 is coupled to the column 32. The first moving plate 42 is placed on the upper side of the fixing plate 41. The first moving plate 42 is placed on the upper side of the fixing plate 41. The first moving plate 42 has a U shape in plan view in which one side in the Y1 direction is opened. The second moving plate 43 is placed on the upper side of the first moving plate 42. The second moving plate 43 has a rectangular shape with a hollow inside in a plan view with an open center. The gripping plate 44 is placed below the fixing plate 41. The gripping plate 44 is coupled to the second moving plate 43 by a connecting member 45. Consequently, the gripping plate 44 moves integrally with the second moving plate 43. A gripping mechanism 36 (FIG. 9) is provided on a lower surface of the gripping plate 44. The gripping mechanism 36 is a mechanism for gripping the container F1, and has a claw portion and a drive mechanism for moving the claw portion to the side.

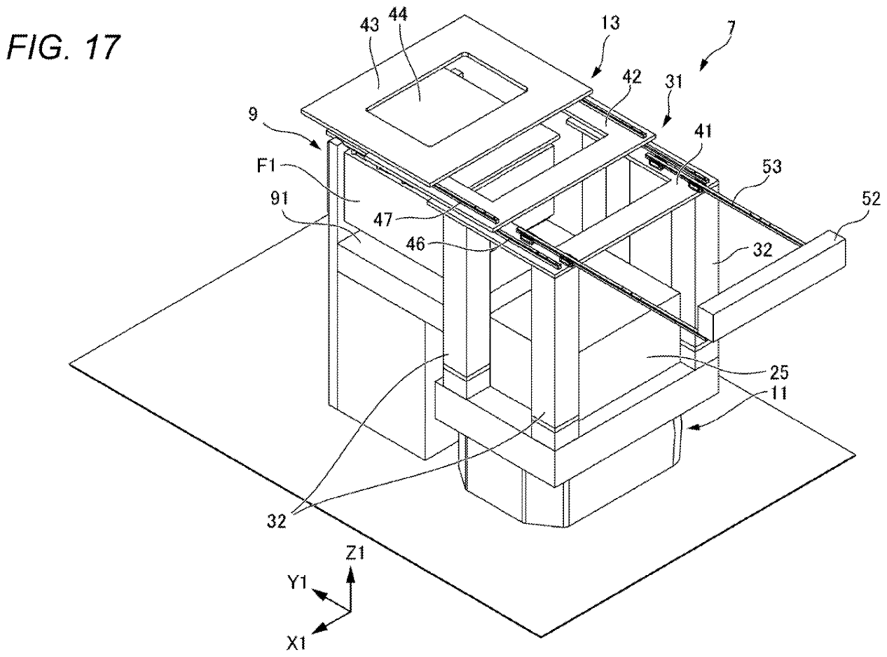

The first moving plate 42 is supported by the first slide mechanism 46 (FIG. 17) so as to be movable in the Y1 direction with respect to the fixing plate 41. The second moving plate 43 is supported by the second slide mechanism 47 (FIG. 17) so as to be movable in the Y1 direction with respect to the first moving plate 42. Each of the first slide mechanism 46 and the second slide mechanism 47 includes a linear drive mechanism and a linear guide. The linear drive mechanism is, for example, a ball screw mechanism. Note that the linear drive mechanism may include a linear motion guide groove, a rack and a pinion, or a chain and a sprocket.

The first slide mechanism 46 and the second slide mechanism 47 are independently driven by two motors. The first slide mechanism 46 and the second slide mechanism 47 may be driven by one motor in conjunction with each other.

The opening and closing part 13 has a counterweight 52. With the counterweight 52, it is possible to keep balance when the transfer mechanism 31 transfers the container F1 from the container mounting part 12 to the load port 3. Therefore, the automatic conveyance vehicle 7 is less likely to fall when the container F1 is transferred. In the present embodiment, in particular, since the counterweight 52 is provided in the opening and closing part 13, it is possible to sufficiently cancel the rotational moment acting in the transfer direction. In general, in a case in which an article is held by a mechanism in an upper portion of an automatic conveyance vehicle, a center of gravity becomes high, and a moment arm (a distance from a center of rotation to the center of gravity) on which gravity acts becomes long. In addition, since the container moves in the transfer direction and a large rotational moment is generated, there is a possibility that the automatic conveyance vehicle easily falls. In particular, in recent years, with the increase in size of wafers and panels, the increase in size and weight of the FOUP has progressed, and thus there is concern about the above problems. In the present embodiment, the above problem is solved or reduced.

The counterweight 52 is supported by a weight slide mechanism 53 so as to be movable in the Y1 direction with respect to the fixing plate 41. Note that the moving side of the counterweight 52 in the Y1 direction is opposite to the moving sides of the first moving plate 42 and the second moving plate 43. The weight slide mechanism 53 includes a linear drive mechanism and a linear guide.

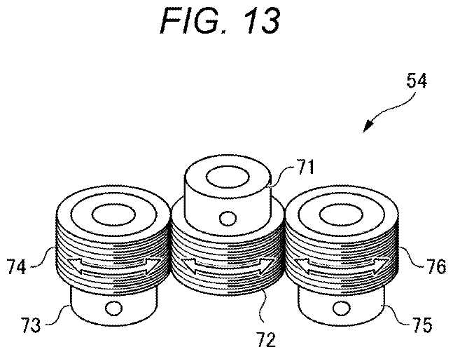

As illustrated in FIG. 13, a synchronous movement mechanism 54 that synchronizes the transfer mechanism 31 and the weight slide mechanism 53 is provided. FIG. 13 is a perspective view illustrating part of a synchronous drive system of a transfer mechanism. The synchronous movement mechanism 54 synchronously moves the counterweight 52 in a direction opposite to the direction in which the container F1 moves in response to the transfer mechanism 31 transferring the container F1 from the container mounting part 12 to the load port 3. Specifically, as illustrated in FIG. 13, the synchronous movement mechanism 54 has a main gear 72 fixed to a shaft 71 of one motor (not illustrated), a first driven gear 74 meshed with the main gear 72, and a second driven gear 76 meshed with the main gear 72. The first driven gear 74 is coupled to the shaft 73 of the transfer mechanism 31. The second driven gear 76 is coupled to the shaft 75 of the weight slide mechanism 53. Accordingly, the transfer mechanism 31 and the weight slide mechanism 53 are simultaneously driven. Note that, in the present embodiment, the moving speed, the moving start timing, and the moving end timing of the container F1 and those of the counterweight 52 are set to be the same. However, the synchronous movement means that the container F1 and the counterweight 52 move to the opposite side for at least a certain period of time, and their moving speeds, the moving start timings, or the moving end timings may be different from each other.

As a modification of the synchronous movement mechanism, the transfer mechanism and the weight slide mechanism may have separate motors, and the controller 50 (described later) may simultaneously drive both motors.

### (5) Control Configuration of Automatic Conveyance Vehicle

A control configuration of the automatic conveyance vehicle 7 will be described with reference to FIG. 3. FIG. 3 is a block diagram illustrating a control configuration of the automatic conveyance vehicle 7. The conveyance facility 1 has a controller 50 that controls the automatic conveyance vehicle 7. In the present embodiment, the automatic conveyance vehicle 7 has a controller 50.

The controller 50 is a computer system having a processor (For example, CPU), a storage device (for example, ROM, RAM, HDD, SSD, and the like), and various interfaces (for example, an A/D converter, a D/A converter, a communication interface, or the like.). The controller 50 as a control unit performs various control operations when a program stored in a storage unit (corresponding to a part or all of a storage area of a storage device) is executed.

The controller 50 may be configured by a single processor, or may be configured by a plurality of independent processors for respective controls.

Some or all of the functions of the respective elements of the controller 50 may be implemented as a program executable by a computer system constituting the controller 50. In addition, a part of the function of each element of the controller 50 may be configured by a custom IC.

Although not illustrated, the controller 50 has a unit to transmit to and receive from the host controller, thereby receiving a conveyance command from the host controller and reporting a conveyance result and a current position to the host controller.

As illustrated in FIG. 3, the controller 50 can drive these actuators by transmitting control signals to the traveling part 11, the opening and closing mechanism 35, the gripping mechanism 36, the transfer mechanism 31, the lifting mechanism 33, and the horizontal movement mechanism 28.

Furthermore, the controller 50 can receive detection signals from the seating sensor 27, the X1-direction distance sensor 29, and the Y1-direction distance sensor 30.

### (6) Operation of Transferring FOUP From Overhead Conveyance Vehicle to Automatic Conveyance Vehicle

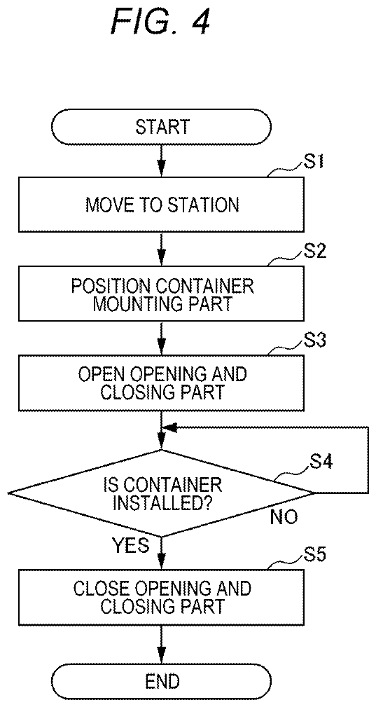

An operation of transferring the FOUP from the overhead conveyance vehicle to the automatic conveyance vehicle will be described with reference to FIG. 4. FIG. 4 is a flowchart for explaining control of transferring a container from the overhead conveyance vehicle to the automatic conveyance vehicle.

The control flowchart described below is an exemplification, and each step can be omitted or replaced as necessary. In addition, a plurality of steps may be executed simultaneously, or some or all of the steps may be executed in an overlapping manner.

Furthermore, each block of the control flowchart is not limited to a single control operation, and can be replaced with a plurality of control operations represented by a plurality of blocks.

Note that the operation of each device is a result of a command from the controller 50 to each device, and these are expressed by each step of the software application.

In step S1, the automatic conveyance vehicle 7 travels to the designated station 6 as illustrated in FIGS. 5 to 7 based on a command from a host controller (not illustrated).

A stop direction of the automatic conveyance vehicle 7 at the station 6 will be described. As illustrated in FIGS. 5 to 7, the Y1 direction which is the left-right direction of the automatic conveyance vehicle 7 faces the first wall 62, and the X1 direction which is the front-rear direction faces the pair of second walls 63. That is, the Y1 direction is parallel to the pair of second walls 63, and the X1 direction is parallel to the first wall 62.

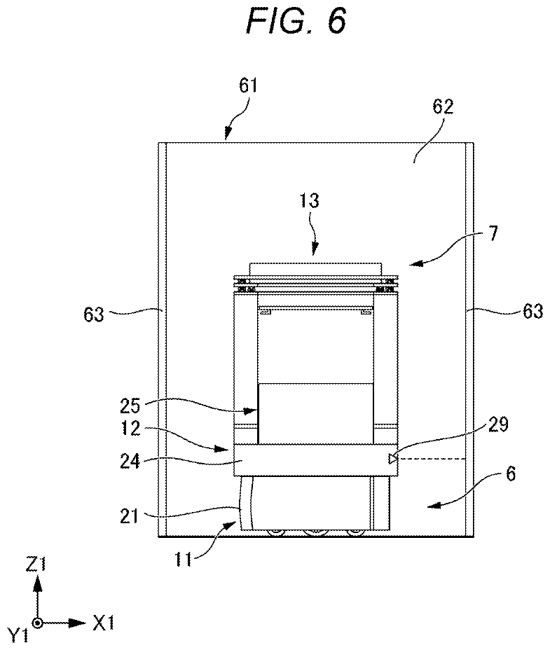

In step S2, the container mounting part 12 is positioned with respect to the traveling part 11. Specifically, first, after the traveling part 11 stops at the station 6, the X1-direction distance sensor 29 and the Y1-direction distance sensor 30 measure the distance between the container mounting part 12 and the fence 61. In the above measurement, the controller 50 (mounting part positioning control unit) transmits a laser drive signal to the X1-direction distance sensor 29 and the Y1-direction distance sensor 30, and causes the light emitters of these sensors to emit a laser as illustrated in FIGS. 6 and 7. Furthermore, the controller 50 receives detection signals from the light receiving units of these sensors. Consequently, the controller 50 calculates the distance between the X1-direction distance sensor 29 and the second wall 63 and the distance between the Y1-direction distance sensor 30 and the first wall 62 based on the time from the emission of the laser light to the reception of the reflected light.

Next, the controller 50 drives the horizontal movement mechanism 28 based on the above-described distance to move the container mounting part 12 with respect to the traveling part 11. That is, after the automatic conveyance vehicle 7 moves to the station 6, the container mounting part 12 is positionally adjusted with respect to the traveling part 11 by the X1-direction distance sensor 29, the Y1-direction distance sensor 30, and the controller 50. As a result, the positional accuracy of the container mounting part 12 is improved. In the transfer of the container F1 to and from the overhead conveyance vehicle 5, since the moving distance of the transfer mechanism of the overhead conveyance vehicle 5 is long, high positioning accuracy may be required on the container mounting part side. On the other hand, the positioning accuracy based on the stop position control of the automatic conveyance vehicle 7 having the traveling part 11 is limited. According to the present embodiment, after the automatic conveyance vehicle 7 stops based on the conveyance destination information, the container mounting part 12 is further positionally adjusted by the horizontal movement mechanism 28, so that the container mounting part 12 is positioned with high accuracy.

In step S3, the opening and closing part 13 moves from the first position illustrated in FIG. 8 to the second position illustrated in FIG. 9 (that is, the opening and closing part 13 is opened). Specifically, the controller 50 drives the opening and closing mechanism 35 to execute the above operation. FIG. 8 is a perspective view of the automatic conveyance vehicle when the opening and closing part is at the first position. FIG. 9 is a perspective view of the automatic conveyance vehicle when the opening and closing part is at the second position.

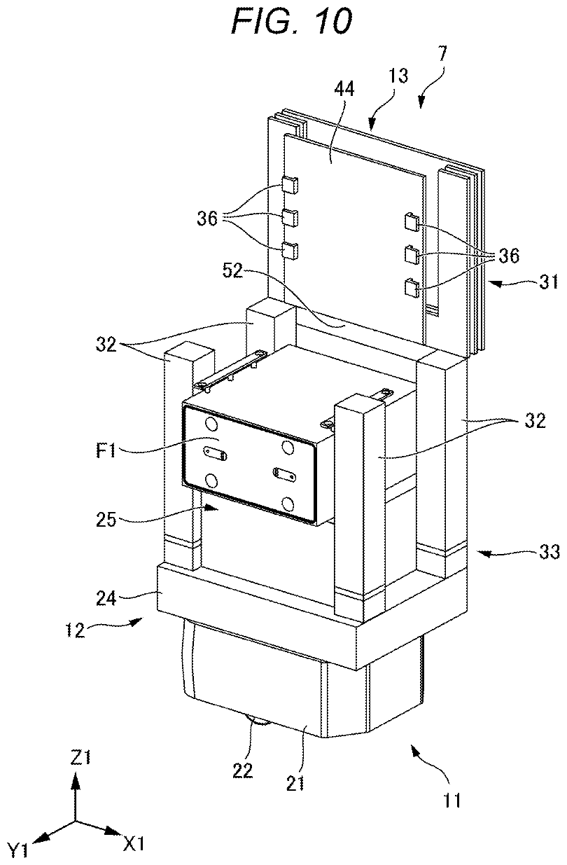

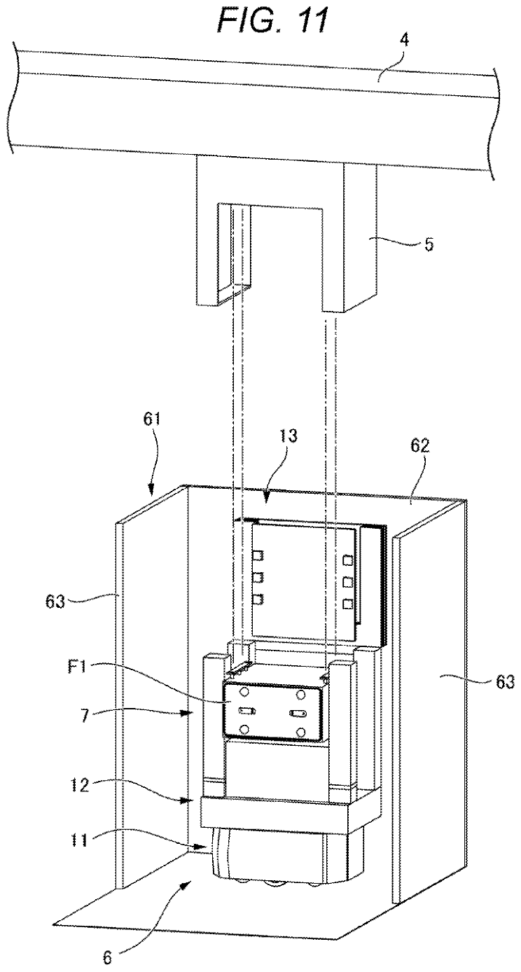

In step S4, as illustrated in FIG. 9, the controller 50 waits for transfer of the container F1 from the overhead conveyance vehicle 5 to the container mounting part 12. Specifically, the controller 50 waits for a detection signal from the seating sensor 27. When the container F1 is transferred to the container mounting part 12 as illustrated in FIGS. 10 and 11, the process proceeds to step S5. FIG. 10 is a perspective view of the automatic conveyance vehicle when the container is transferred from the overhead conveyance vehicle to the automatic conveyance vehicle. FIG. 11 is a perspective view of the automatic conveyance vehicle and the overhead conveyance vehicle when the container is transferred from the overhead conveyance vehicle to the automatic conveyance vehicle. As described above, the automatic conveyance vehicle 7 transfers the container F1 between the overhead conveyance vehicle 5 and the container mounting part 12 in a state in which the opening and closing part 13 is at the second position. A gap of 10 mm or more is secured between the container F1 and the four columns 32.

In step S5, the opening and closing part 13 moves from the second position to the first position as illustrated in FIG. 2 (that is, the opening and closing part 13 is closed). Specifically, the controller 50 drives the opening and closing mechanism 35 to execute the above operation.

With the above, the process ends.

Note that the operation of transferring the container F1 from the automatic conveyance vehicle 7 to the overhead conveyance vehicle 5 is performed in the order opposite to the above-described operation.

As described above, the automatic conveyance vehicle 7 of the present embodiment is an automatic conveyance vehicle used in the conveyance facility 1 including the overhead conveyance vehicle 5, and the opening and closing part 13 of the automatic conveyance vehicle 7 moves from the first position to the second position when transferring the container F1 between the overhead conveyance vehicle 5 and the automatic conveyance vehicle 7. Specifically, the controller 50 moves the opening and closing part 13 to the second position when transferring the container F1 between the overhead conveyance vehicle 5 and the automatic conveyance vehicle 7.

### (7) Operation of Transferring FOUP From Automatic Conveyance Vehicle to Load Port

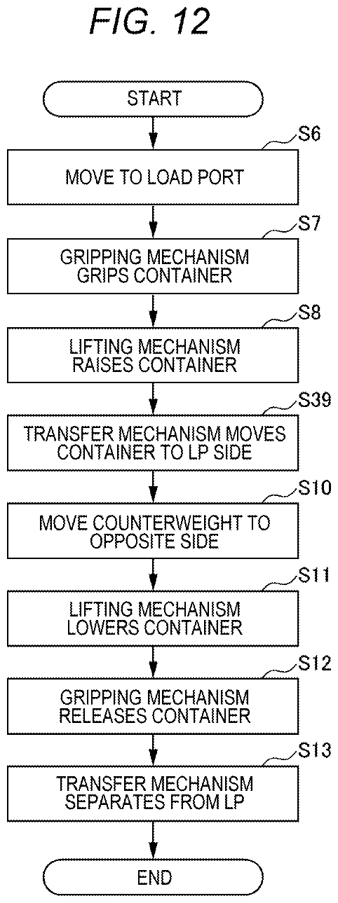

An operation of transferring the FOUP from the automatic conveyance vehicle to the load port will be described with reference to FIG. 12. FIG. 12 is a flowchart for explaining control of transferring the container from the automatic conveyance vehicle to the load port.

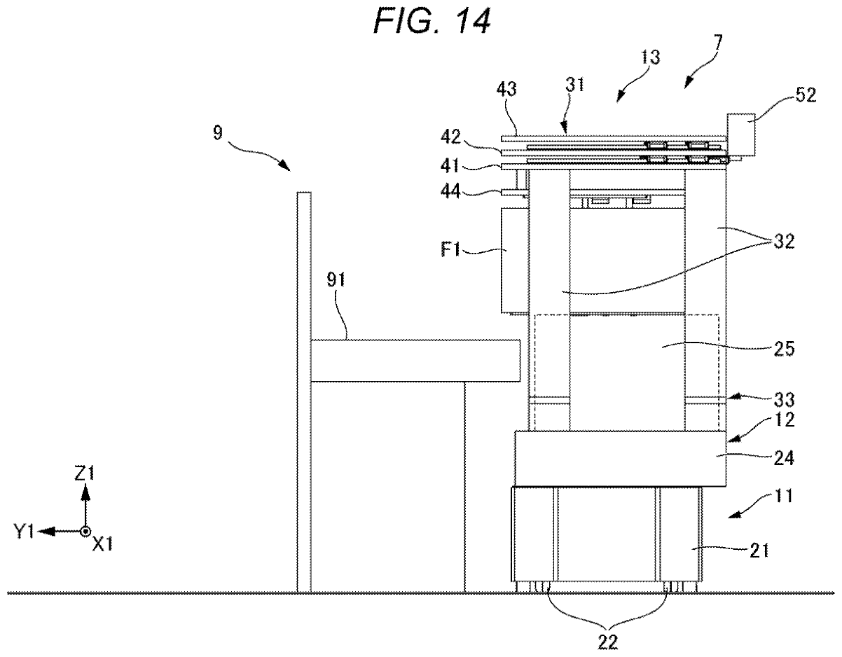

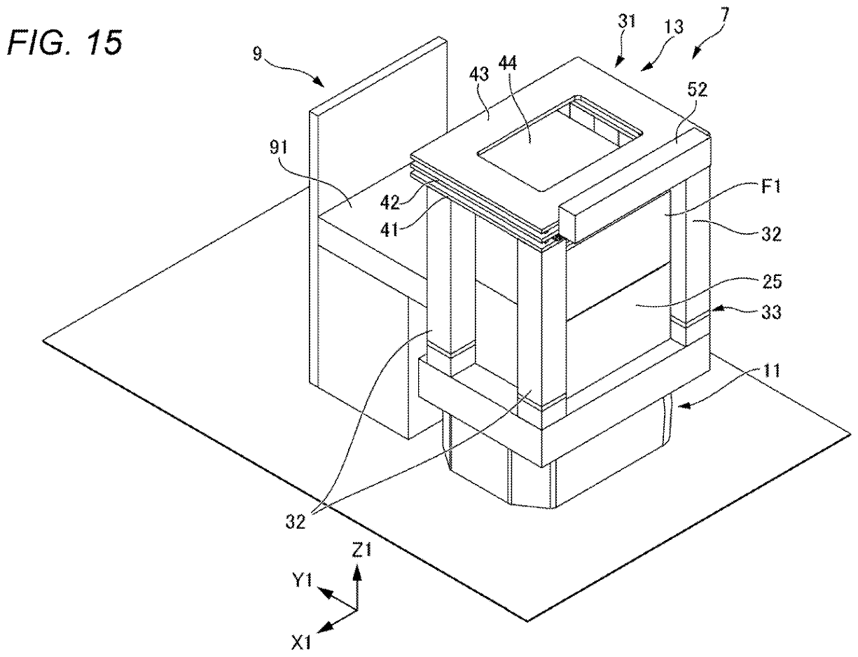

In step S6, the automatic conveyance vehicle 7 travels to the extra-track region load port 9 as illustrated in FIGS. 14 and 15 based on a command from the host controller (not illustrated). FIG. 14 is a front view of the automatic conveyance vehicle stopped at the load port. FIG. 15 is a perspective view of the automatic conveyance vehicle stopped at the load port.

A stop position and a stop direction of the automatic conveyance vehicle 7 will be described. As illustrated in FIGS. 14 and 15, the automatic conveyance vehicle 7 stops close to the front side of the extra-track region load port 9. In the automatic conveyance vehicle 7, the X1 direction which is the front-rear direction coincides with the left-right direction of the extra-track region load port 9, and the Y1 direction which is the left-right direction coincides with the front-rear direction of the extra-track region load port 9. In this state, the transfer mechanism 31 moves the container F1 in the Y1 direction (intersecting direction intersecting the front-rear direction) to transfer the container F1 to the extra-track region load port 9.

As described above, the automatic conveyance vehicle 7 is close to the front side of the extra-track region load port 9. Therefore, as illustrated in FIG. 14, one side portion in the Y1 direction of the opening and closing part 13 of the automatic conveyance vehicle 7 is located above the one side portion in the Y1 direction of a mounting surface 91 of the extra-track region load port 9 (both overlap each other in plan view). With such a structure, the automatic conveyance vehicle 7 can be brought close to the extra-track region load port 9, and the traveling space and the stop space of the automatic conveyance vehicle 7 can be reduced.

As illustrated in FIG. 14, in the automatic conveyance vehicle 7, the centers of the container mounting part 12 and the opening and closing part 13 in the Y1 direction are shifted to the opposite side of the extra-track region load port 9 with respect to the center of the traveling part 11 in the Y1 direction. The plurality of columns 32 are also placed to be biased to the side opposite to the extra-track region load port 9 with respect to the center of the traveling part 11 in the Y1 direction. With this configuration, the center of gravity of the automatic conveyance vehicle 7 is located on the side separated from the extra-track region load port 9 as a whole. As a result, the automatic conveyance vehicle 7 is less likely to fall toward the extra-track region load port 9 during the transfer operation to be described later. The above configuration may be realized by the horizontal movement mechanism 28 before or after the automatic conveyance vehicle 7 stops. In this case, the horizontal movement mechanism 28 functions as a center-of-gravity movement mechanism. As a modification, the above configuration may be permanent.

In step S7, the gripping mechanism 36 grips the container F1.

In step S8, the lifting mechanism 33 raises the container F1. Specifically, the lifting mechanism 33 raises the column 32 and the gripping plate 44, and accordingly, the container F1 is raised. As a result, the bottom of the container F1 is disengaged from the kinematic pin (not illustrated) of the container mounting surface 26.

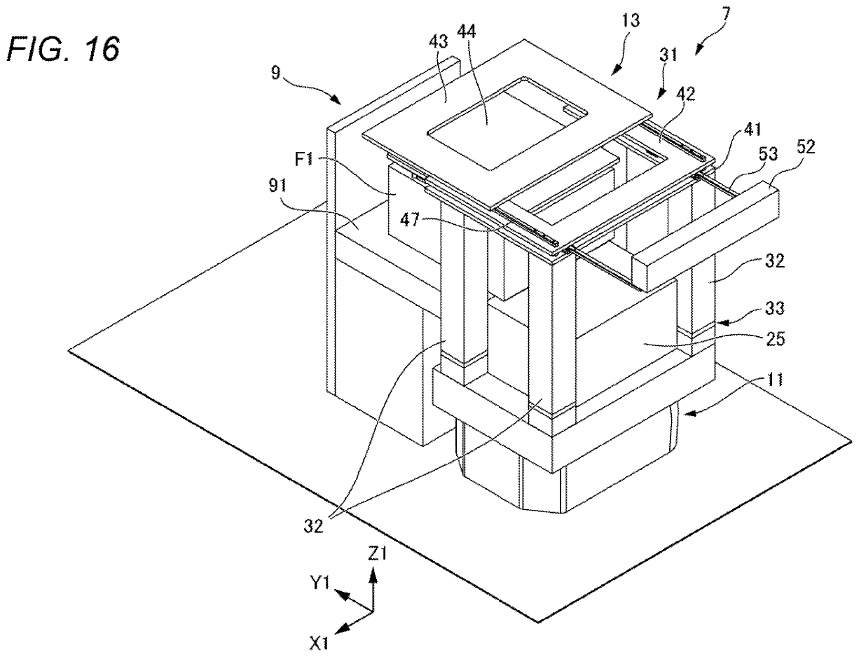

In step S9, as illustrated in FIGS. 16 and 17, the transfer mechanism 31 moves the container F1 toward the extra-track region load port 9. Specifically, the second moving plate 43 first moves with respect to the first moving plate 42 as illustrated in FIG. 16, and then the first moving plate 42 moves with respect to the fixing plate 41 as illustrated in FIG. 17. FIG. 16 is a perspective view illustrating a first state in which the transfer mechanism moves the FOUP toward the load port side. FIG. 17 is a perspective view illustrating a second state in which the transfer mechanism moves the FOUP toward the load port side.

In step S10, as illustrated in FIGS. 16 and 17, the synchronous movement mechanism 54 (FIG. 13) synchronously moves the counterweight 52 in a direction opposite to the direction in which the container F1 moves. Step S10 is performed simultaneously with step S9. Since the counterweight 52 is synchronously moved in the direction opposite to the container transfer direction in this manner, the rotational moment acting in the container transfer direction can be effectively canceled. Note that, in step S10 and step S9, all operations may be performed simultaneously, or some operations may be performed simultaneously.

In step S11, the lifting mechanism 33 lowers the container F1. As a result, the container F1 is mounted on the mounting surface 91 of the extra-track region load port 9.

In step S12, the gripping mechanism 36 releases the container F1.

In step S13, the transfer mechanism 31 is separated from the extra-track region load port 9. Specifically, the first moving plate 42, the second moving plate 43, and the gripping plate 44 return to above the container mounting part 12.

With the above, the process ends.

Note that the operation of transferring the container F1 from the extra-track region load port 9 to the overhead conveyance vehicle 5 is performed in the order opposite to the above-described operation.

As described above, the automatic conveyance vehicle 7 of the present embodiment is an automatic conveyance vehicle used in the conveyance facility 1 including the overhead conveyance vehicle 5 and the extra-track region load port 9. The opening and closing part 13 of the automatic conveyance vehicle 7 moves from the first position to the second position when transferring the container F1 between the overhead conveyance vehicle 5 and the automatic conveyance vehicle 7, and the transfer mechanism 31 transfers the container F1 between the automatic conveyance vehicle 7 and the extra-track region load port 9 in a state in which the opening and closing part 13 is at the first position. Specifically, when transferring the container F1 between the overhead conveyance vehicle 5 and the automatic conveyance vehicle 7, the controller 50 performs control to move the opening and closing part 13 to the second position, and performs control to transfer the container F1 between the automatic conveyance vehicle 7 and the extra-track region load port 9 by the transfer mechanism 31 in a state in which the opening and closing part 13 is at the first position.

### 2. Second Embodiment

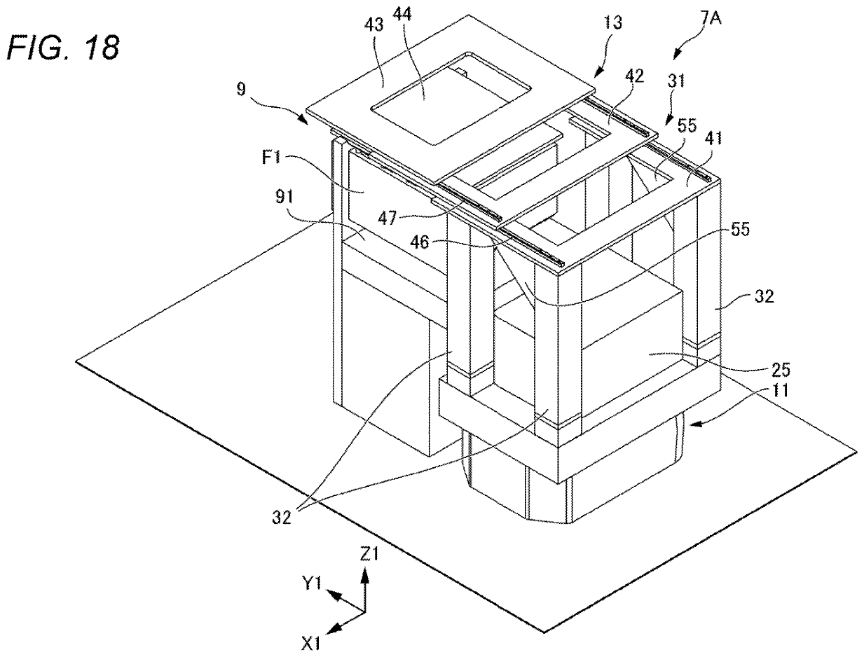

A second embodiment will be described with reference to FIG. 18. FIG. 18 is a perspective view of an automatic conveyance vehicle according to a second embodiment of the present invention. Since the basic configuration and the basic operation of the second embodiment are the same as those of the first embodiment, different points will be mainly described below.

Unlike the first embodiment, the automatic conveyance vehicle 7A has a weight member 55 for locating the center of gravity of the automatic conveyance vehicle 7A at a portion opposite to the extra-track region load port 9. The weight member 55 is provided on the upper portion of the automatic conveyance vehicle 7A on the side opposite to the extra-track region load port 9. Specifically, the weight member 55 means two ribs fixed to the upper portion of the column 32 on the opposite side of the extra-track region load port 9 and the fixing plate 41.

With the weight member 55, it is possible to keep balance when the transfer mechanism 31 transfers the container F1 from the container mounting part 12 to the extra-track region load port 9. Therefore, the automatic conveyance vehicle 7 is less likely to fall when the container F1 is transferred. In the present embodiment, in particular, since the weight member 55 is provided on the upper portion of the automatic conveyance vehicle 7A, it is possible to sufficiently cancel the rotational moment acting in the transfer direction.

The shape, material, number, and mounting position of the weight member are not particularly limited.

### 3. Third Embodiment

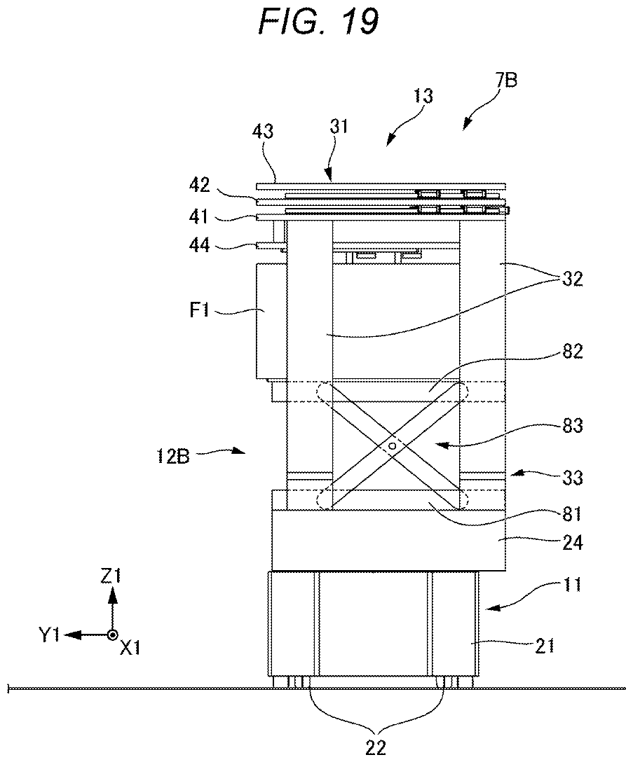

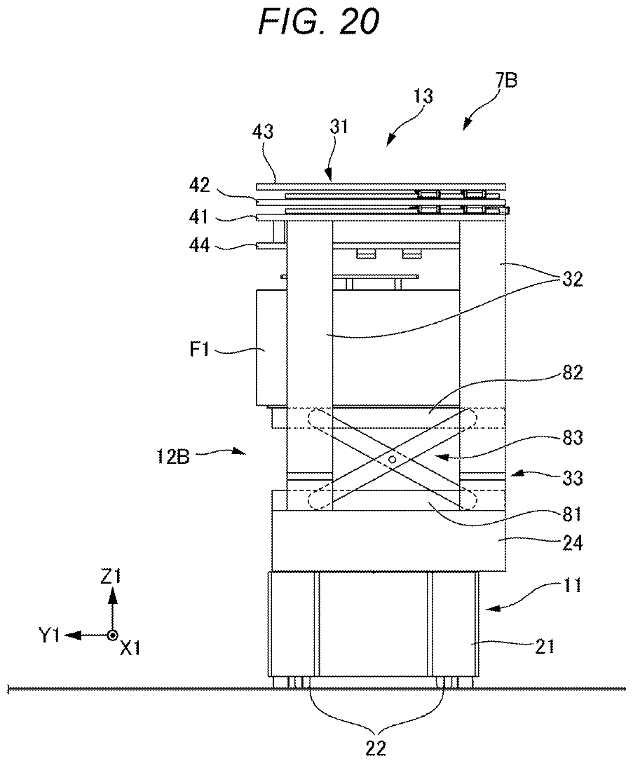

A third embodiment will be described with reference to FIGS. 19 and 20. FIG. 19 is a front view of an automatic conveyance vehicle (stopped) according to a third embodiment of the present invention. FIG. 20 is a front view of the automatic conveyance vehicle (during conveyance) according to the third embodiment of the present invention. Since the basic configuration and the basic operation of the third embodiment are the same as those of the first embodiment, different points will be mainly described below.

The container mounting part 12B is installed on the traveling part 11. The container mounting part 12B has a structure for supporting the container F1 from below. The container mounting part 12B has a function of raising and lowering the container F1.

The container mounting part 12B is a pair of pantograph mechanisms, and has a base 81, a lifting table 82, and a pair of crossed link arms 83. The container mounting part 12B has an actuator (not illustrated) for raising and lowering the pantograph. The actuator is, for example, a motor.

The base 81 is located below the pantograph mechanism.

The lifting table 82 is located above the pantograph mechanism and has a container mounting surface.

The pair of link arms 83 is rotatably connected by a hinge.

As illustrated in FIG. 19, when the container F1 is transferred to the load port, the container mounting part 12B places the container F1 at a high position.

As illustrated in FIG. 20, when the automatic conveyance vehicle 7B travels, the container mounting part 12B places the container F1 at a low position. Consequently, the center of gravity of the automatic conveyance vehicle 7B decreases during traveling, and thus traveling is stabilized.

Note that the lifting mechanism of the container mounting part 12B may be of another type other than the pantograph.

### 4. Other Embodiments and Modifications

Although a plurality of embodiments of the present invention have been described above, the present invention is not limited to the above embodiments, and various modifications can be made without departing from the gist of the invention. In particular, a plurality of embodiments and modifications described in the present specification can be arbitrarily combined as necessary.

### (1) Modification of Load Port

The automatic conveyance vehicle may transfer the container to and from a load port provided in the semiconductor processing apparatus in the track.

The automatic conveyance vehicle may transfer the container to and from the load port of the automatic warehouse.

### (2) Modification of Opening and Closing Mechanism

The opening and closing mechanism may swing the opening and closing member from the first position to the second position by 90 degrees or more.

The opening and closing mechanism may move the opening and closing member from the first position to the second position by sliding the opening and closing member laterally.

### (3) Modification of Transfer Mechanism

The transfer mechanism may be a mechanism in which one member extends laterally, or a mechanism in which three or more members extend laterally.

The order of starting the movement of the plurality of members of the transfer mechanism is not particularly limited. The plurality of members may be moved simultaneously.

### (4) Modification of Counterweight

A counterweight does not need to be provided.

The counterweight may be immovably fixed to, for example, a fixing plate of the opening and closing part.

According to the above-described embodiment, the following effects are obtained.
(1) The automatic conveyance vehicle travels on a floor surface. The automatic conveyance vehicle includes a traveling part, an article mounting part, and an opening and closing part. The opening and closing part is provided above the article mounting part, and is movable between a first position directly above the article mounting part and a second position deviated from directly above the article mounting part.

According to (1), in the automatic conveyance vehicle, when the opening and closing part is at the second position, the article can be transferred to the article mounting part from directly above the article mounting part. Therefore, the automatic conveyance vehicle can directly receive the article from, for example, the overhead conveyance vehicle, and can thereafter convey the article to the article mounting device.
(2) In the automatic conveyance vehicle of (1), in a state in which the opening and closing part is at the second position, the article is transferred between an overhead conveyance vehicle traveling along a track provided on a ceiling and the article mounting part.

According to (2), in the automatic conveyance vehicle, when the opening and closing part is at the second position, the article can be transferred to the article mounting part from directly above the article mounting part. Therefore, the automatic conveyance vehicle can directly receive the article from, for example, the overhead conveyance vehicle, and can thereafter convey the article to the article mounting device.
(3) In the automatic conveyance vehicle of (1) or (2), the opening and closing part has a transfer mechanism. The transfer mechanism transfers the article between the article mounting part and an article mounting device by moving the article to the side in a suspended state.

According to (3), in the automatic conveyance vehicle, the article can be transferred from directly above the article mounting part when the opening and closing part is at the second position, and also, for example, when the opening and closing part is at the first position, the transfer mechanism can transfer the article to the article mounting device.
(4) In the automatic conveyance vehicle of (3), the opening and closing part has a counterweight. The counterweight is a member that is to keep balance when the transfer mechanism transfers the article from the article mounting part to the article mounting device.

According to (4), with the counterweight, it is possible to keep balance when the transfer mechanism transfers the article from the article mounting part to the article mounting device. Therefore, the automatic conveyance vehicle is less likely to fall at the time of transferring the article. In the present embodiment, since the counterweight is provided in the opening and closing part, it is possible to sufficiently cancel the rotational moment acting in the transfer direction. In general, in a case in which an article is held by a mechanism in an upper portion of an automatic conveyance vehicle, a center of gravity becomes high, and a moment arm (a distance from a center of rotation to the center of gravity) on which gravity acts becomes long. In addition, since the article moves in the transfer direction and a large rotational moment is generated, the automatic conveyance vehicle easily falls.
(5) In the automatic conveyance vehicle of (4), the opening and closing part has a synchronous movement mechanism. The synchronous movement mechanism synchronously moves the counterweight in a direction opposite to a direction in which the article moves when the transfer mechanism transfers the article from the article mounting part to the article mounting device.

According to (5), since the counterweight is synchronously moved in the direction opposite to the article moving direction, the rotational moment acting in the transfer direction can be effectively canceled. That is, as the rotational moment acting in the transfer direction increases, the rotational moment acting on the opposite side can be increased.
(6) In the automatic conveyance vehicle of (3), the automatic conveyance vehicle further includes a weight member for locating a center of gravity of the automatic conveyance vehicle at a portion opposite to the article mounting device.

According to (6), the automatic conveyance vehicle is less likely to fall due to the weight member at the time of transferring the article. That is, the rotational moment acting in the transfer direction can be sufficiently canceled by the weight member.
(7) The conveyance facility includes the automatic conveyance vehicles according to (1) to (6), an overhead conveyance vehicle, and a station. The overhead conveyance vehicle travels along a track provided on a ceiling to transport an article. The station is located below the track and the automatic conveyance vehicle is allowed to stop at the station. The overhead conveyance vehicle stops at the station and transfers the article to the article mounting part of the automatic conveyance vehicle whose opening and closing part is at a second position.

According to (7), in the conveyance facility, when the opening and closing part of the automatic conveyance vehicle is at the second position, the article can be transferred from directly above the article mounting part. Therefore, the automatic conveyance vehicle can directly receive the article from the overhead conveyance vehicle, and can thereafter convey the article to the article mounting device.
(8) In the conveyance facility of (7), the automatic conveyance vehicle stops in the vicinity of an article mounting device, and in a state in which the opening and closing part is at the first position, the transfer mechanism transfers the article to and from the article mounting device.

According to (8), the automatic conveyance vehicle can convey the article transferred from the overhead conveyance vehicle to the article mounting device and transfer the article to the article mounting device.
(9) The conveyance facility of (7) or (8) further includes a fence that blocks at least one side of the automatic conveyance vehicle stopped at the station.

According to (9), the safety of the worker is secured by the fence.
(10) In the conveyance facility of (9), the automatic conveyance vehicle further has a horizontal movement mechanism, a sensor, and a mounting part positioning control unit. The horizontal movement mechanism is capable of moving the article mounting part in the horizontal direction with respect to the traveling part. The sensor measures a distance between the article mounting part and the fence after the traveling part stops at the station. The mounting part positioning control unit moves the article mounting part with respect to the traveling part by driving the horizontal movement mechanism based on the distance.

According to (10), after the automatic conveyance vehicle moves to the station, the article mounting part is positionally adjusted with respect to the traveling part by the measurement unit and the article positioning and transferring determination control unit. As a result, the positional accuracy of the article mounting part is improved.
(11) The conveyance facility includes the automatic conveyance vehicles according to (1) to (6), an overhead conveyance vehicle, a station, and an article mounting device. The automatic conveyance vehicle stops at the station, and in a state in which the opening and closing part is at the second position, transfers the article to and from the overhead conveyance vehicle, and the automatic conveyance vehicle stops in the vicinity of the article mounting device, and in a state in which the opening and closing part is at the first position, the transfer mechanism transfers the article to and from the article mounting device.

According to (11), the automatic conveyance vehicle can convey the article transferred from the overhead conveyance vehicle to the article mounting device and transfer the article to the article mounting device.
(12) An automatic conveyance vehicle that travels on a floor surface and is used in a conveyance facility including an overhead conveyance vehicle that travels along a track provided on a ceiling to convey an article, in which
the automatic conveyance vehicle includes a traveling part, an article mounting part, and an opening and closing part provided above the article mounting part and movable between a first position directly above the article mounting part and a second position deviated from directly above the article mounting part, and
the opening and closing part moves from the first position to the second position when transferring the article between the overhead conveyance vehicle and the automatic conveyance vehicle.
(13) An automatic conveyance vehicle that travels on a floor surface and is used in a conveyance facility including an overhead conveyance vehicle that travels along a track provided on a ceiling to convey an article and an article mounting device, in which
the automatic conveyance vehicle includes a traveling part, an article mounting part, and an opening and closing part provided above the article mounting part and movable between a first position directly above the article mounting part and a second position deviated from directly above the article mounting part, and the opening and closing part has a transfer mechanism that transfers an article between the article mounting part and the article mounting device, and
the opening and closing part moves from the first position to the second position when the article is transferred between the overhead conveyance vehicle and the automatic conveyance vehicle, and the transfer mechanism transfers the article between the automatic conveyance vehicle and the article mounting device in a state in which the opening and closing part is at the first position.
(14) An automatic conveyance vehicle that travels on a floor surface and is used in a conveyance facility including an overhead conveyance vehicle that travels along a track provided on a ceiling to convey an article and a control unit (processor), in which
the automatic conveyance vehicle includes a traveling part, an article mounting part, and an opening and closing part provided above the article mounting part and movable between a first position directly above the article mounting part and a second position deviated from directly above the article mounting part, and
the control unit (processor) moves the opening and closing part to the second position when transferring the article between the overhead conveyance vehicle and the automatic conveyance vehicle.
(15) An automatic conveyance vehicle that travels on a floor surface and is used in a conveyance facility including an overhead conveyance vehicle that travels along a track provided on a ceiling to convey an article, an article mounting device, and a control unit (processor), in which
the automatic conveyance vehicle includes a traveling part, an article mounting part, and an opening and closing part provided above the article mounting part and movable between a first position directly above the article mounting part and a second position deviated from directly above the article mounting part, and the opening and closing part has a transfer mechanism that transfers an article between the article mounting part and the article mounting device, and
the control unit (processor) performs control to move the opening and closing part to the second position when the article is transferred between the overhead conveyance vehicle and the automatic conveyance vehicle, and performs control to transfer the article between the automatic conveyance vehicle and the article mounting device by the transfer mechanism in a state in which the opening and closing part is at the first position.
(16) An automatic conveyance vehicle includes a traveling part, an article mounting part, a transfer mechanism, and a counterweight. The transfer mechanism transfers the article between the article mounting part and an article mounting device by moving the article to the side in a suspended state. The counterweight is a member that is to keep balance when the transfer mechanism transfers the article from the article mounting part to the article mounting device.

According to (16), with the counterweight, it is possible to keep balance when the transfer mechanism transfers the article from the article mounting part to the article mounting device. Therefore, the automatic conveyance vehicle is less likely to fall at the time of transferring the article.
(17) The conveyance facility includes an automatic conveyance vehicle, an overhead conveyance vehicle, and a station. The automatic conveyance vehicle includes a traveling part and an article mounting part. The station has a fence. The automatic conveyance vehicle further has a horizontal movement mechanism capable of moving the article mounting part in a horizontal direction with respect to the traveling part, a sensor that measures a distance between the article mounting part and the fence after the traveling part stops at the station, and a mounting part positioning control unit that moves the article mounting part with respect to the traveling part by driving the horizontal movement mechanism on the basis of the distance.

According to (17), after the automatic conveyance vehicle moves to the station, the article mounting part is positionally adjusted with respect to the traveling part by the measurement unit and the article positioning and transferring determination control unit. As a result, the positional accuracy of the article mounting part is improved.

### REFERENCE SIGNS LIST

1 Conveyance facility
2 Semiconductor processing device
3 Load port (article mounting device)
4 Ceiling rail (track)
5 Overhead conveyance vehicle
6 Station
7 Automatic conveyance vehicle
7A Automatic conveyance vehicle
7B Automatic conveyance vehicle
8 Extra-track region semiconductor processing device
9 Extra-track region load port
11 Traveling part
12 Container mounting part (article mounting part)
12B Container mounting part (article mounting part)
13 Opening and closing part
28 Horizontal movement mechanism
29 X1-direction distance sensor (sensor)
30 Y1-direction distance sensor (sensor)
31 Transfer mechanism
35 Opening and closing mechanism
36 Gripping mechanism
50 Controller (mounting part positioning control unit)
52 Counterweight
53 Weight slide mechanism
54 Synchronous movement mechanism
55 Weight member
61 Fence
F1 Container (article)

1. An automatic conveyance vehicle that travels on a floor surface, the automatic conveyance vehicle comprising:
a traveling part;
an article mounting part; and
an opening and closing part provided above the article mounting part and movable between a first position directly above the article mounting part and a second position deviated from directly above the article mounting part.

2. The automatic conveyance vehicle according to claim 1, wherein in a state in which the opening and closing part is at the second position, an article is transferred between an overhead conveyance vehicle traveling along a track provided on a ceiling and the article mounting part.

3. The automatic conveyance vehicle according to claim 2, wherein
the opening and closing part has a transfer mechanism that transfers the article between the article mounting part and an article mounting device by moving the article in a suspended state.

4. The automatic conveyance vehicle according to claim 3, wherein
the opening and closing part has a counterweight that is to keep balance when the transfer mechanism transfers the article from the article mounting part to the article mounting device.

5. The automatic conveyance vehicle according to claim 4, wherein
the opening and closing part has a synchronous movement mechanism that synchronously moves the counterweight in a direction opposite to a direction in which the article moves when the transfer mechanism transfers the article from the article mounting part to the article mounting device.

6. The automatic conveyance vehicle according to claim 3, further comprising a weight member for locating a center of gravity of the automatic conveyance vehicle at a portion opposite to the article mounting device.

7. A conveyance facility comprising:
the automatic conveyance vehicle according to claim 3;
an overhead conveyance vehicle that travels along a track provided on a ceiling and conveys an article; and
a station that is located below the track and at which the automatic conveyance vehicle is allowed to stop, wherein
the overhead conveyance vehicle stops at the station and transfers the article to the article mounting part of the automatic conveyance vehicle whose opening and closing part is at the second position.

8. The conveyance facility according to claim 7, wherein the automatic conveyance vehicle stops in a vicinity of an article mounting device, and in a state in which the opening and closing part is at the first position, the transfer mechanism transfers the article to and from the article mounting device.

9. The conveyance facility according to claim 7, further comprising a fence that blocks at least one side of the automatic conveyance vehicle stopped at the station.

10. The conveyance facility according to claim 9, wherein
the automatic conveyance vehicle further comprises
a horizontal movement mechanism capable of moving the article mounting part in a horizontal direction with respect to the traveling part,
a sensor that measures a distance between the article mounting part and the fence after the traveling part stops at the station, and
a mounting part positioning control unit that moves the article mounting part with respect to the traveling part by driving the horizontal movement mechanism on a basis of the distance.

11. A conveyance facility comprising:
the automatic conveyance vehicle according to claim 3;
an overhead conveyance vehicle that travels along a track provided on a ceiling and conveys an article;
a station that is located below the track and at which the automatic conveyance vehicle is allowed to stop, and
an article mounting device, wherein
the automatic conveyance vehicle stops at the station, and in a state in which the opening and closing part is at the second position, transfers the article to and from the overhead conveyance vehicle, and
the automatic conveyance vehicle stops in the vicinity of the article mounting device, and in a state in which the opening and closing part is at the first position, the transfer mechanism transfers the article to and from the article mounting device.
